(19) United States
(12) Patent Application Publication
(10) Pub. No.: US 2026/0364627 A1
(43) Pub. Date: Nov. 19, 2026

(54) DEVICE FOR APPLYING A COATING AGENT TO ELONGATED WORKPIECES

(71) Applicant: CEFLA SOCIETA' COOPERATIVA IN SIGLA CEFLA S.C., Imola (BO) (IT)

(72) Inventors: Stephen CAPPANNARI, Charlotte, NC (US); Jason FALLS, Mount Holly, NC (US); Paolo MACCARELLI, Imola (IT)

(73) Assignee: CEFLA SOCIETA' COOPERATIVA IN SIGLA CEFLA S.C., Imola (BO) (IT)

(21) Appl. No.: 19/677,707

(22) Filed: May 14, 2026

(30) Foreign Application Priority Data
May 15, 2025 (IT) 102025000010942

(51) Int. Cl. B05C 5/02; B05C 11/10

(52) U.S. Cl. CPC B05C 5/0241; B05C 11/1039

(57) ABSTRACT

Apparatus (100) for coating a workpiece (66) with a coating agent, comprising a coating chamber (10); said apparatus (100) comprising:
a vacuum pump for generating a negative pressure in the coating chamber (10) compared to the pressure outside the chamber,
a fluid pump (114) and a reservoir for supplying and recycling said coating agent,
conveying means for the workpieces to be coated,
said coating chamber (10) being provided with slots (5) mimicking the shape of the workpiece (66) to be coated through which the workpiece (66) is conveyed, and with a path (49, 59) for said coating agent;
said coating chamber (10) comprises:
   a manifold frame (1) fixedly placed with respect to the coating apparatus (100), comprising at least one vacuum outlet adapter (3), at least one coating inlet adapter (4), O-rings (9), preferably a vacuum sensor adapter (11),
   a coating interchangeable tooling (2, 24, 25, 26),
wherein the tooling (2, 24, 25, 26) is mounted in/dismounted from the manifold frame (1) as an integral box-like unit,
characterized in that
said tooling (2, 24, 25, 26) comprises in this order:
   an entry template (41, 51, 61),
   a centre template (42, 52, 62),
   a diffusion ring (43, 53, 63) with at least one vacuum port (8),
   an exit template (44, 54, 64),
   fixing means (6, 46, 56) and holes (47, 57) for the assembling of the box-like tooling (2, 24, 25, 26),
   the tooling (2, 24, 25, 26) being assembled to the manifold frame (1) preferably with the interposition of O-rings (9) fixedly placed in the manifold frame (1).

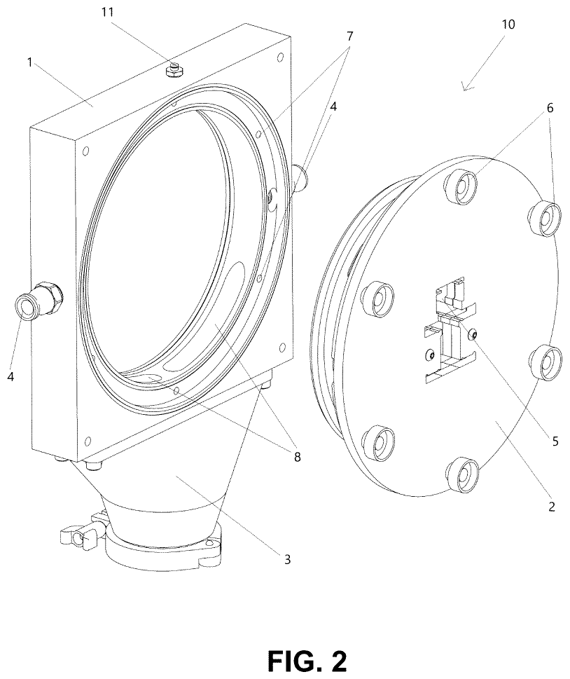

The invention further comprises a method for the use of the apparatus (100) and a method for cleaning it (FIG. 2).

The present invention relates to apparatuses for coating workpieces, in particular elongated workpieces. The invention in particular relates to a coating apparatus comprising a coating chamber consisting of a fixed manifold frame and an interchangeable coating tooling that is assembled off-line and easily mounted as a box-like integral unit in said manifold frame. In the art, this type of devices is known also with the name of vacuum head.

Preferably, the workpieces coated through the present invention are elongated workpieces wherein one dimension is much bigger than the other two dimensions, which tend to be similar. These kinds of workpieces are also referred to as profiles, and these two terms will be used interchangeably in the following. Indicatively, such profiles typically have dimensions of 25 mm-250 mm wide×10 mm-100 mm tall×1000 mm to 6000 mm long, and have a constant shape along their entire length. Profiles are well known in the art and can be made of wood, plastics, metals. With vacuum heads, it is known to coat profiles on their whole perimetral surfaces: this kind of coating is known as all-round coating (360 degrees).

A special kind of profiles that is customarily coated through a device according to the present invention consists in window or door sashes and frames, which typically have cross-sections with complicated contours comprising recesses, cavities, protrusions, undercuts, etc. which make this kind of workpieces particularly difficult to coat.

Typically, window or door profiles do not need to be coated on their whole perimetral surfaces: often they are coated on their outward surfaces only, while the profile surfaces intended to be in contact with the window glass or interior are not coated. This introduces the further problem of partial coating, that is the coating of some of lateral edge surfaces only.

Such coating devices are known in the art, e.g. from EP 2628549A1. This document describes a device for the coating of a workpiece with a coating agent, comprising a coating chamber, a pump for generating in the chamber a negative pressure (vacuum) compared to the pressure outside the chamber, an inlet opening through which the workpiece can be inserted into the chamber, an outlet opening through which the workpiece can be conveyed out of the chamber, and means for applying the coating agent to the workpiece while it is passing through the coating chamber (flood coating).

U.S. Pat. No. 9,266,141 B2 describes a vacuum head for a coating apparatus intended for coating workpiece edges, provided with a coating interchangeable tooling having slots mimicking the shape of the workpiece to be coated through which the workpiece is conveyed. Such tooling is mounted in/dismounted from the manifold frame as an integral box-like unit. The box-like unit is characterized by two slanted plates.

U.S. Pat. No. 5,298,072 A, too, describes a vacuum head for a coating apparatus intended for coating workpiece edges, provided with a coating interchangeable tooling having slots mimicking the shape of the workpiece to be coated through which the workpiece is conveyed. Such tooling is mounted in/dismounted from the manifold frame as an integral box-like unit.

It is to be noted that both tooling of U.S. Pat. No. 9,266,141 B2 and of U.S. Pat. No. 5,298,072 A are used for coating the edge of panels, not for coating profiles, i.e. they cannot provide a coating on all the surfaces of the workpiece.

It is also known that elongated profiles are often warped or bowed, therefore their passing through a vacuum head can be difficult without scraping them, which in turn leads to production waste.

For applying the coating agent, usually inside the coating chamber there is provided at least one nozzle, which is fed with said coating agent taken from a reservoir outside the chamber. Inside the coating chamber there is provided at least a connection to a vacuum pump placed outside the chamber, which provides the negative pressure or vacuum to the coating chamber.

Substantially, in a first step the coating chamber is flooded with the coating agent provided by at least one nozzle, forming a sort of veil or curtain around the workpiece, while in a second step the excess of coating agent is sucked away through said at least one connection to the vacuum pump. The excess coating agent that is not applied to the workpiece is collected in a reservoir and continuously recycled.

It is known to provide a narrow gap between the external surface of the workpiece to be coated and the internal profile (slot) of the coating chamber exit. Indicatively, the gap between the internal profile of the chamber and the external profile of the workpiece to be coated is about 0.5-3.00 mm thick, preferably 1-2 mm. The thickness of this gap provides one possibility to control the thickness of the coating resulting on the profile after the coating operation has taken place. Indicatively, the thickness of the coating layer on the profile is 0.01-0.07 mm, preferably about 0.03 mm, depending on the coating agent.

In addition to the thickness of the above-mentioned gap, in the art it is known that the thickness of the coating agent applied on said workpiece can be further determined by adjusting: a) the viscosity of the liquid coating agent; b) the flow rate of the coating agent through the dispensing slot; c) the conveying speed of said workpiece; d) the degree of suction provided by the vacuum pump recovering the excess coating agent.

In the art it is known to provide, downstream from the coating chamber, a curing station, e.g. an UltraViolet (UV) curing station, in order to trigger the polymerization of the coating agent applied on the workpiece. For instance, the coating agent may comprise an UV photo-initiator that is triggered by a suitable UV wavelength provided by a source of UV light placed after the coated workpiece exits the coating chamber.

In the art, it is known that the shape of the slot through which the profile passes must closely mimic the shape of the profile. This entails that, when changing the set-up of the coating apparatus in order to coat a batch of profiles having a shape different from the preceding batch, the slot shape must be changed, and this leads to downtimes of the coating apparatus. Of course, this also entails that for any profile having a specific shape, a specific corresponding slot must be provided, i.e. specific components must be produced.

Moreover, the coating chamber must be cleaned when using a coating agent with a colour different from the colour of the preceding batch, or a coating agent with a composition different from that of the previous batch: such cleaning operation can be quite difficult and time consuming.

Aim of the present invention is providing a coating apparatus capable of overcoming the above-described drawbacks, that can ease and shorten the set-up and changeover of the coating apparatus.

Such an aim is obtained through a coating apparatus having features according to claim 1. Moreover, the present invention provides a coating method according to claim 12 and a cleaning method according to claim 13.

The vacuum head or coating chamber according to the invention comprises a manifold frame that is a fixed part of the coating apparatus and an interchangeable tooling that is specific for the specific workpiece (profile) to be coated. The manifold frame comprises fixed connections to the coating apparatus, namely a connection to a vacuum pump placed outside the vacuum head and a connection to a fluid pump and a reservoir placed outside the vacuum head for feeding and recycling the coating agent. The coating occurs while workpieces are passing through the coating chamber: the means for conveying the workpieces are well known in the art and will not be described further.

Said tooling is assembled off-line and easily mounted as a box-like single unit in the manifold frame utilizing fixing means accessible from the infeed side. No adjustment between the manifold frame and the tooling is necessary; the tooling is mounted directly in the manifold frame and secured with fixing means. Preferably, the tooling has chamfered edges, and this eases the mounting of the tooling inside the manifold frame. The tooling comprises an entry template, a centre template, a diffusion ring and an exit template. Suitable O-rings in the manifold base make the box-like assembled coating chamber liquid-and air-tight.

In an embodiment, the vacuum head provides 360 degrees coating to the profile to be coated, namely all-round coating.

In an embodiment, the vacuum head provides coating on selected longitudinal portions of the profile, i.e. a partial coating.

In an embodiment, in case of use of a coating agent that must be polymerized, downstream from the coating chamber at least a polymerizing module emitting e.g. an UV wavelength suitable for the photo-initiator contained in the coating agent is provided.

In an embodiment, a specific tooling is provided, intended for performing cleaning operation. The cleaning tooling is very similar to a coating tooling, i.e. is a box-like tooling that is assembled off-line and is mounted in the manifold frame. As it is to be used for cleaning and not for coating, the entry template and the exit template are not provided with the slot that in the coating tooling allows the passage of the workpiece to be coated. This arrangement allows the cleaning solution to circulate closed within the vacuum chamber and manifold frame.

The present invention also comprises a method for coating different batches of workpieces, i.e. profiles having different shapes. The method according to the present invention comprises the following steps:
A. machining three templates (entry template, centre template and exit template) so as to obtain a slot mimicking the shape of the workpiece to be coated and a suitable path for the coating agent;
B. assembling the three templates with the interposition of a diffusion ring between the centre template and the exit template, through fixing means, to provide a first tooling that is assembled into an integral box-like unit;
C. mounting the first tooling as a single box-like unit into the manifold frame utilizing fixing means accessible from the infeed side. No adjustment between the manifold frame and the tooling is necessary. The manifold frame is provided with suitable fixed O-rings that make the joint with the tooling air-and liquid-tight. The manifold frame completed with the tooling, that is the entire coating chamber, is mounted on an adjustable axis for fine alignment to match the profile being conveyed;
D. starting the coating operation, coating a first batch of workpieces having a shape suitable for the slot of the first tooling;
E. at the end of the workpiece batch, cleaning the coating chamber;
F. for a new second batch of workpieces having a different shape from the shape of the first slot, providing a second tooling according to steps A-B;
G. optionally, tooling may include a shroud/mask or outfeed guides that are inserted into the tooling when partial coating has to be provided;
H. mounting the second tooling into the manifold frame like in step C, so that the production cycle of the second batch can start.

The method for cleaning operation according to step E comprises the following steps:
a. dismounting the used first coating tooling from the manifold frame;
b. replacing the dismounted first coating tooling with a cleaning tooling, which is mounted in the manifold frame through the same fixing means and holes;
c. emptying the coating agent reservoir, and filling it with a suitable solvent or cleaning solution:
d. circulating said cleaning solution in the same way as the coating agent through the coating apparatus, following the same path of the coating agent;
e. after a suitable time (or after a suitable quantity of cleaning solution circulated in the coating apparatus), replacing the cleaning tooling with a second, clean coating tooling suitable for the next batch to be coated;
f. disassembling the dirty first coating tool and cleaning it off-line, preparing it in order to be used for a future batch.

Understandably, the cleaning method according to the present invention allows to minimize the downtime of the coating apparatus. All assembling, disassembling and cleaning steps are manually performed by human operators.

The present invention is provided with many advantages.

The first advantage of the present invention is that it provides the possibility of 360 degrees coating (all-round coating) of any linear profile having any shape, even if provided with recesses, cavities, protrusions, undercuts.

The second advantage of the present invention is that it also provides the possibility of coating less than 360 degrees of the profile, that is partial coating of the profile.

A third advantage is that during the set-up of the coating apparatus vacuum/coating/pressure sensing lines never need to be disconnected from the manifold frame for tooling change, which makes the set-up change much easier and quicker.

The novel narrow width (the total thickness or depth in the direction of workpieces conveying) of the coating chamber allows the following advantages:
minimizes material usage, in particular coating agent usage, while still allowing for very customized tooling;
minimizes workpiece bending due to warped workpieces;
minimizes the distance between workpiece driving contact point before the coating chamber and driving contact point after the coating chamber, which is beneficial in order to reduce the required minimum length of the profiles. The coating chamber according to the invention is thinner: from the 200 mm of the known art to the 50 mm of the coating chamber according to the present invention. This allows shorter workpieces to be coated.

Another advantage is that the present invention markedly reduces the required air pressure of the vacuum. Indicatively, in coating apparatuses according to the known art, the required vacuum air flow rate is 0.15-0.25 bar, while according to the present invention the vacuum air flow rate can be reduced to 0.05-0.12 bar.

A further advantage is that the present invention greatly reduces required coating agent flow rate. Indicatively, in coating apparatuses according to the known art, the required coating agent flow rate is 60-75 litres/minute, while according to the present invention the coating agent flow rate can be reduced to 10-20 litres/minute.

These last two advantages translate into a lower manufacturing and operating cost of the coating apparatus comprising the vacuum head according to the present invention: on the one hand, the supply of energy for actuating both the vacuum pump and the coating agent pump is lower, and on the other hand, the vacuum chamber and its annexes take up less space in comparison with apparatuses according to the known art.

The present invention greatly reduces the manufacturing cost of vacuum heads, so that a specific vacuum head precisely fit for any profile can be produced, improving the final quality of the coated profiles.

Finally, thanks to the cleaning tooling, cleaning operations are easier and quicker, with reduced downtimes of the coating apparatus.

These and other features of the present invention will become more apparent from the following detailed description of some practical embodiments thereof, shown by way of non-limiting examples in the accompanying drawings, in which:

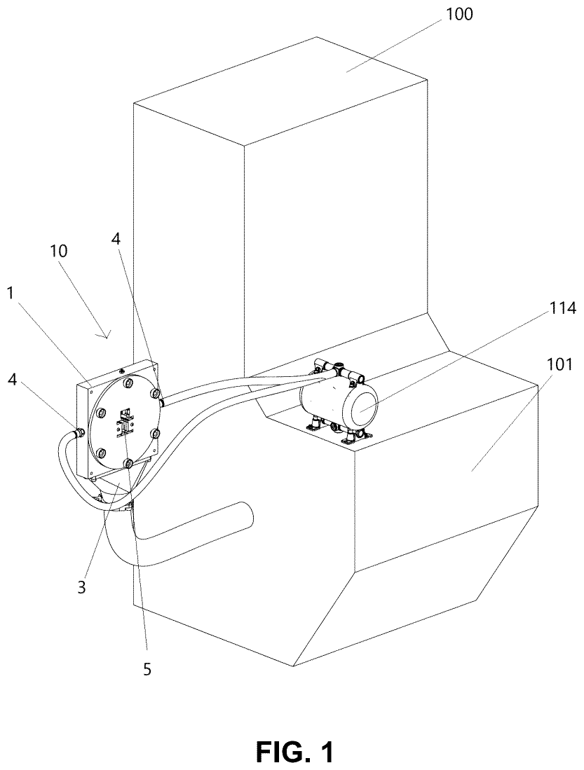

FIG. 1 shows an axonometric view of a coating apparatus according to the present invention;

FIG. 2 shows an exploded axonometric view of a coating chamber, consisting in the manifold base and the profile tooling according to the present invention;

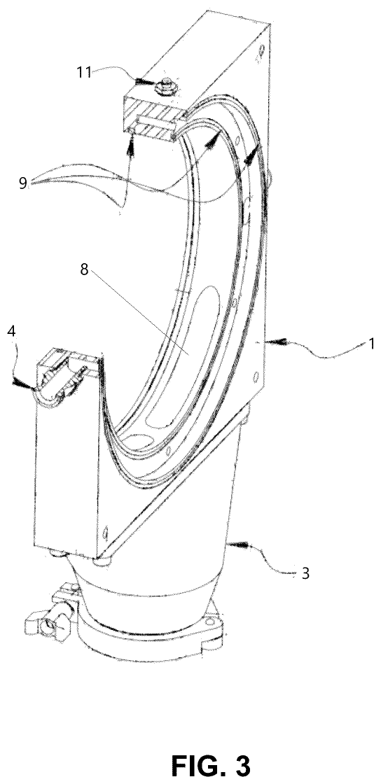

FIG. 3 shows a section of the manifold frame of the coating chamber;

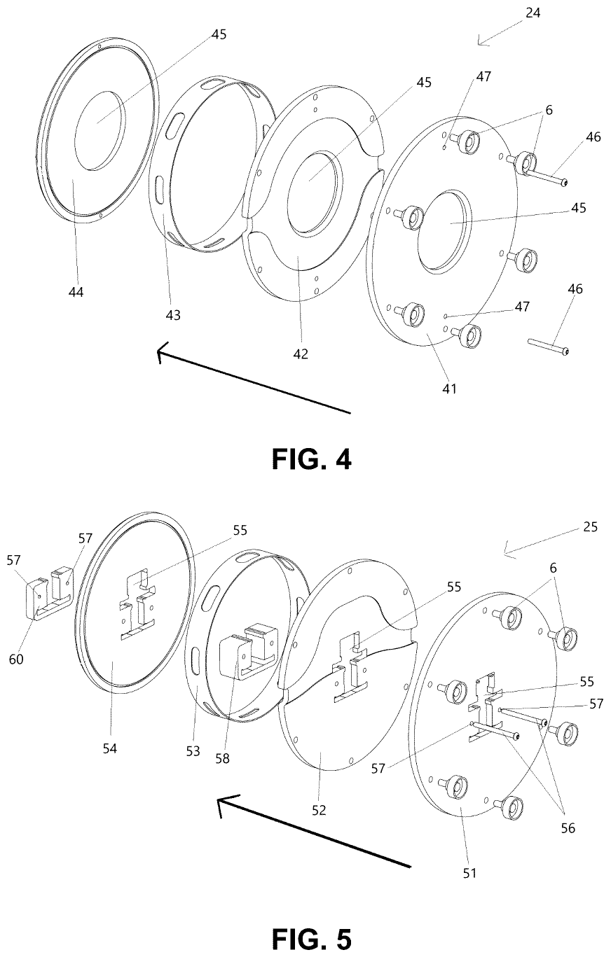

FIG. 4 shows an exploded axonometric view of a simple tooling for a circular profile;

FIG. 5 shows an exploded axonometric view of a tooling for coating a profile having a complex shape requiring selective coating;

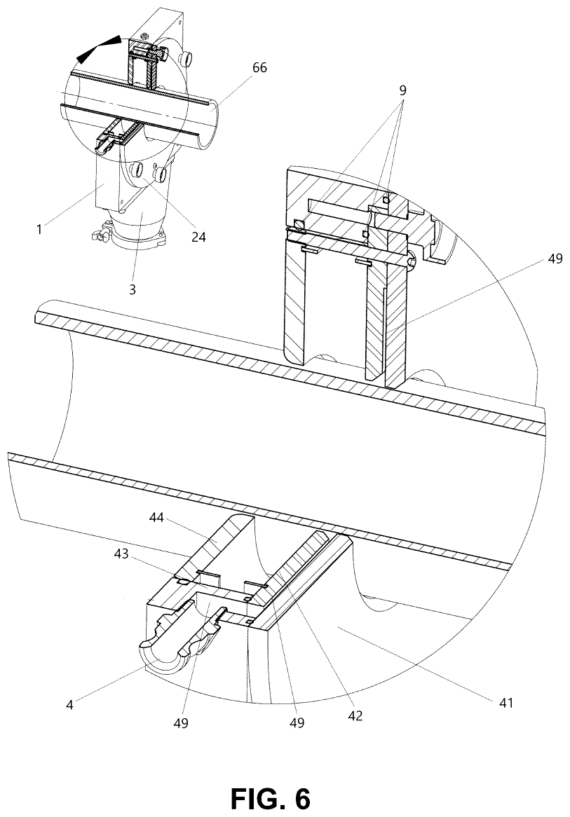

FIG. 6 shows a section of the simple tooling of FIG. 4 installed into the manifold frame and the workpiece, wherein the encircled portion is shown magnified;

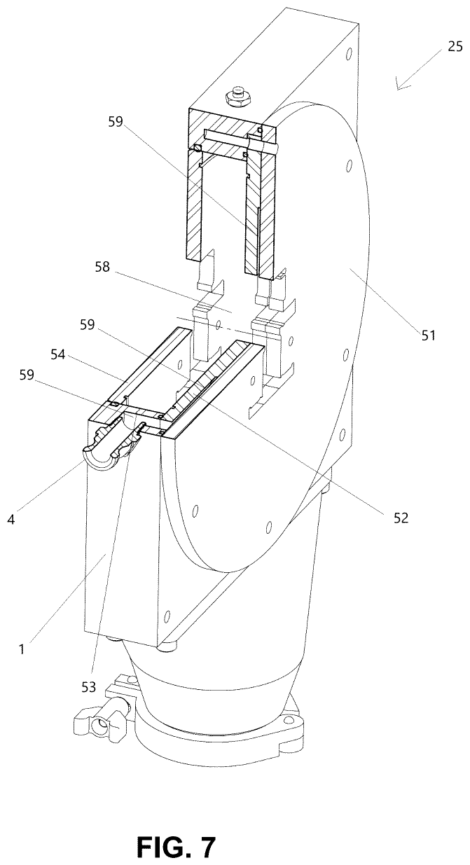

FIG. 7 shows a section of the tooling of FIG. 5 installed into the manifold frame;

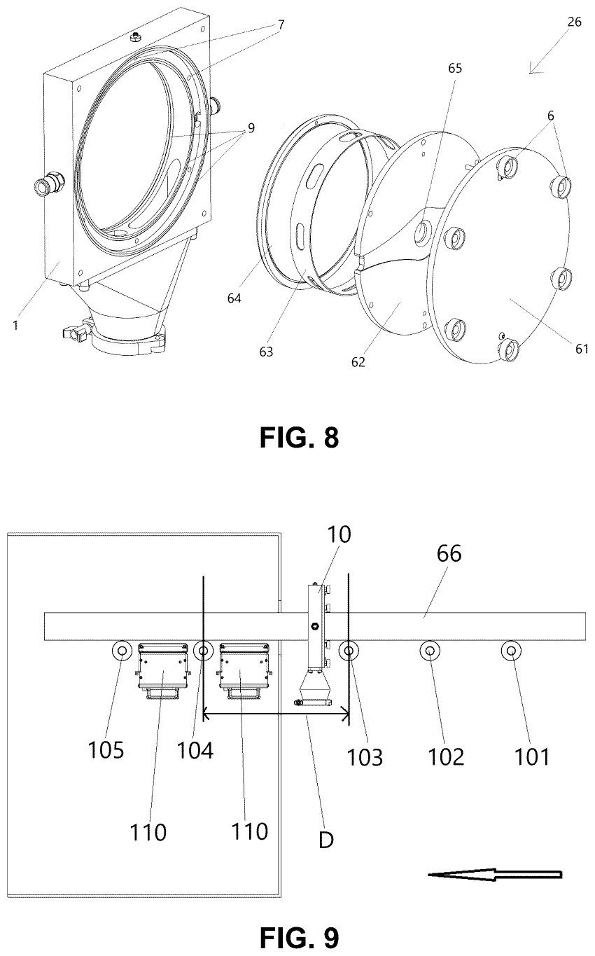

FIG. 8 shows an exploded axonometric view of a cleaning tooling with the base manifold, provided for cleaning operations;

FIG. 9 shows a side view of a coating apparatus comprising a coating chamber according to the present invention, wherein two UV polymerizing emitters are provided.

FIG. 1 shows an axonometric view of a coating apparatus 100 comprising a coating chamber 10 according to the present invention. On the one hand, the coating chamber 10 is provided with at least one vacuum outlet adapter 3, which is connected to a vacuum pump (not shown) intended for providing a negative pressure in the chamber 10, that is a lower pressure compared to the pressure outside the chamber 10. On the other hand, the manifold frame 1 is provided with at least one coating agent inlet adapter 4, preferably two inlet adapters 4. Said inlet adapters 4 are connected to a coating pump 114, which draws the coating agent from a reservoir 101 of coating agent. All this is well known in the art and will not be described in more detail. The coating chamber 10 is provided with a tooling with slots 5, mimicking very closely the shape of a (not shown) profile to be coated.

FIG. 2 shows an exploded axonometric view of the coating chamber 10. Said coating chamber 10 comprises a fixed manifold frame 1 and an interchangeable tooling 2. This figure also allows to observe that the vacuum outlet adapter 3 is fixedly connected to the manifold frame 1. The same fixed connection is provided for the two coating agent inlet adapters 4, which are provided on the sides of the frame 1, as is a vacuum sensor adapter 11. The tooling 2 is assembled off-line and easily mounted as a single box-like unit in the manifold frame 1 using fixing means 6 accessible from the infeed side. In a preferred embodiment, the tooling 2 is connected to the frame 1 through six fixing means 6, that are six hand-knobs that are manually screwed into six corresponding holes 7 provided on the manifold frame 1. The number and shape of fixing means 6 and holes 7 are such that no horizontal and vertical adjustment of the tooling 2 with respect to the manifold frame 1 is needed. The fact that the vacuum outlet adapters 3, coating inlet adapters 4, O-rings 9, and vacuum sensor adapter 11 are fixed parts of the manifold frame 1 allows a very easy and fast set-up of the coating apparatus, when a batch change is needed. Moreover, the fact that the entry template 41, 51 has a diameter bigger than the exit template 44, 54 (see also FIGS. 4 and 5), in a funnel-like way, also easies the assembling of the tooling 2 into the manifold frame 1. The tooling 2 enters into the manifold frame 1 like a nail into its hole, the head of the nail being the entry template and the tip of the nail being the exit template. This figure also allows to appreciate that the profiles to be coated can be provided with a very complex shape, with recesses and protrusions.

The overall thickness (or depth) measured from the workpiece entry point to the exit point of the coating chamber 10 according to the present invention is about 50 mm, while in the known art a coating chamber may be 200 mm thick or more.

In the manifold frame 1, there is provided at least one vacuum port 8 through which the excess coating agent is suctioned through the vacuum outlet adapter 3 to the coating reservoir by the vacuum pump.

FIG. 3 shows a section of the manifold frame 1. The manifold frame 1 houses the tooling 2, and is provided with coating inlet adapters 4, vacuum outlet adapter(s) 3, and a vacuum sensor adapter 11. O-rings 9, in particular three O-rings 9, are provided to seal around each of the three templates 41, 42, 44 or 51, 52, 54 of the tooling visible in FIGS. 4 and 5, creating a zone of positive pressure coating between the infeed template 41 or 51 and centre plate 42 or 52, and a zone of vacuum (negative pressure) between the centre plate 42 or 52 and the exit template 44 or 54.

In an embodiment, there are provided two ports 8; preferably said ports 8 are placed on the bottom of the manifold frame 1. In a different embodiment, in particular one intended for all-round coating, a plurality of ports is placed all around the vacuum chamber (not shown). In an embodiment for all-round coating, the manifold frame 1 is provided with two vacuum outlet adapters, symmetrically placed on the opposite sides of the manifold frame 1 (not shown).

FIG. 4 shows a set of parts of a simple tooling 24 for coating a circular profile, e.g. a tube 66 (visible in FIG. 6), in which all 360 degrees are to be coated (all-round coating). The feeding direction of the profile to be coated is shown by the bold arrow. The coating agent is pumped between the entry template 41 and the centre plate 42, which is provided with a slot 45 having the same shape as the slot of central template and exit template. The infeed face of the centre plate 42 has been machined down to create a gap and allow the coating agent to surround the linear workpiece on 360 degrees (the machined path 49 of the coating agent is better visible in FIG. 6). The unmachined infeed face surface of the centre plate 42 is maintained around the mounting holes to allow the back of the entry template 41 to enter into contact, forcing the centre plate 42 into the O-ring 9. The diffusion ring 43 sets the gap between the centre plate 42 and the exit template 44. All the components of the tooling 24 are held together as an integral single box-like assembly with a pair of through bolts 46 and respective holes 47.

FIG. 5 shows a coating tooling 25 for a profile (not shown) having a more complex shape provided with recesses and protrusions that is to be partially coated. The feeding direction of the profile to be coated is indicated by the bold arrow. The coating agent is pumped between the entry template 51 and the centre template 52, which is provided with a slot 55 having the same shape as the slot of entry template and exit template. In this case the coating gap between the entry plate 51 and the centre plate 52 has been selectively machined in the centre plate 52 to allow the coating agent to access only predetermined zones of the profile, supplied through the coating path 59 (shown in FIG. 7). The flow rate of coating agent to certain zones of the profile can be controlled by varying the depth of the machined gap (this example only shows a single depth of gap). In addition to the diffusion ring 53 and exit template 54, this tooling 25 includes a shroud/mask 58 and an outfeed guide 60. The outfeed guide 60 has the aim of guiding warped profiles by holding the uncoated section of the workpiece (in partial coating). All the components of the tooling 25 are held together as a single box-like assembly with through bolts 56 and holes 57.

A comparison between FIG. 4 and FIG. 5 allows to appreciate that the place of the holes 57 can be varied according to need. In case the tooling is provided with an outfeed guide 60, the same holes 57 and bolts 56 can be used to keep the outfeed guide 60 integral with the tooling 25.

In some embodiments, the edges of the slots 45, 55 are machined flat (90° angle), while in other embodiments the edges of the slot 45, 55 are bevelled (in the entry or in the exit portion of the slot) in order to facilitate the conveying of the profile or to improve the airflow around the workpiece.

FIG. 6 shows a cross section of the simple tooling 24 mounted in the manifold frame 1. A section of a workpiece to be coated, in this case a tube 66, is also shown. Note the coating path 49 originating from the adapter 4 fitting on the side of the manifold frame 1, into the manifold frame, into the machined gap in the centre plate 42, surrounding the workpiece 360 degrees into the vacuum chamber and finally out through the vacuum adapter 3. The magnification of the cross-section allows to appreciate the path 49 of the coating agent from the coating inlet adapter 4 to the machined space 49 between the entry template 41 and the centre template 42. The machined gaps between entry template 41 and centre template 42 can be better appreciated by observing FIG. 4.

FIG. 7 shows a cross section of the tooling 25 installed into the manifold frame 1. This more complicated tooling is designed for partial coating. Note the difference in coating path 59 as it cannot completely surround the workpiece 360 degrees. In this case, the shroud/mask 58 has the aim of hindering the coating agent from reaching all the peripheral surfaces of the profile to be coated. The magnification of the cross-section allows to appreciate the path 59 of the coating agent from the coating inlet adapter 4 to the space between the entry template 51 and the centre template 52. The machined gaps between entry template 51 and centre template 52 can be better appreciated by observing FIG. 5.

The width of the coating path 49 or 59 can be varied by differently machining the centre template 42 or 52, or, in other embodiments, by inserting a suitable spacer.

The inlet of the coating agent is provided between entry template 41 or 51 and centre template 42 or 52, while the vacuum is provided between centre template 42 or 52 and exit template 44 or 54. The first zone of application of the coating and the second zone of vacuum suction are separated by the centre template 42 or 52. The first zone only applies the coating agent while the second zone only suctions the coating agent.

In practice, when a new profile with a new shape has to be coated, the method according to the present invention comprises the following steps:
A. machining three templates (entry template 41, centre template 42 and exit template 44) so as to obtain a slot 45 mimicking the shape of the workpiece to be coated and a suitable coating path 49;
B. assembling the three templates (entry template 41, centre template 42 and exit template 44) with the interposition of a diffusion ring 43 between the centre template 42 and the exit template 44, and holding them together through bolts 46 and holes 47, to provide a first tooling 24 that is a box-like integral part;
C. mounting easily the first tooling 24 as a single box-like unit in the manifold frame 1 provided with suitable fixed O-rings 9, utilizing fixing means 6 and holes 7 accessible from the infeed side; no adjustment between the manifold frame 1 and the tooling 2 is necessary;
D. starting the coating operation, coating a first batch of workpieces having a shape suitable for the slot 45 of the first tooling 24;
E. at the end of the workpiece batch, cleaning the coating chamber 10, if needed;
F. for a new second batch of workpieces having a different shape from the shape of first slot 45 providing a second coating tooling 25, according to steps A-B;
G. optionally, inserting a shroud/mask 58 and/or an outfeed guide 60 in the tooling 25 when partial coating has to be provided;
H. mounting the second tooling 25 into the manifold frame 1 like in step C, so that the production cycle of a new batch can start.

In an embodiment, a specific tooling 26 is provided, intended for performing cleaning operations according to step E. FIG. 8 shows a cleaning tooling according to the present invention. The cleaning tooling 26 is shaped like the coating tooling 24, 25, i.e. it is a box-like tooling that is interchangeably mounted in the manifold frame 1. The cleaning tooling 26 comprises an entry template 61, a centre template 62, a diffusion ring 63 and an exit template 64; analogously is kept together as a box-like unit by a couple of bolts and holes; the entry template 61 has a diameter bigger than the exit template 64. A slot 65 in the centre template 62 allows the cleaning solution to circulate inside the cleaning tooling 26 and manifold frame 1. On the other hand, the cleaning tooling 26 lacks the slots 5 on the entry template 61 and exit template 64. Due to lack of slots 5 in the entry template 61 and exit template 64, the cleaning solution may only go directly from the coating inlet adapters 4 through the centre template 63 into the vacuum adapter 3 and return back to the coating agent reservoir.

The cleaning method according to the present invention comprises the following steps:
a. dismounting the used first coating tooling 24 from the manifold frame 1;
b. replacing the dismounted coating tooling 24 with a cleaning tooling 26, which is mounted in the manifold frame 1 through the same fixing means 6 and holes 7;
c. emptying the coating agent reservoir and filling it with a suitable solvent or cleaning solution: the solvent can be water in case of water-based coating agents or an organic solvent in case of organic-based coating agents;
d. circulating said cleaning solution through the coating apparatus, following the same path of the coating agent;
e. after a suitable time (or after a suitable quantity of cleaning solution circulated in the coating apparatus), replacing the cleaning tool 26 with a second, clean coating tooling 25 specific for the next batch to be coated;
f. disassembling the first, dirty coating tool 24 and cleaning it off-line, and preparing it in order to be used for a future batch.

Understandably, this cleaning method allows to minimize the downtime of the coating apparatus.

FIG. 9 shows a lateral view of a production line comprising a coating chamber 10 according to the present invention. The big arrow shows the conveying direction of the profiles to be coated. The example production line diagram comprises two polymerizing stations 110 downstream the coating chamber 10. The production line comprises transport rollers 101, 102, 103, 104, 105, which are typically used to convey workpieces 66. The figure allows to appreciate the minimization of the distance D between the last roller 103 upstream the coating chamber 10 and the first roller 104 downstream the coating chamber 10 and the first polymerizing station 110. Distance D is the distance between the central axis of the last transport roller 103 upstream the coating chamber 10 and the central axis of the first transport roller 104 downstream the first polymerizing unit 110. The minimization of distance D is obtained thanks to the reduced thickness of the coating chamber 10 in comparison to the known art; according to the present invention, distance D is reduced by 150 mm in comparison to the common standard of the known art. This allows to coat shorter workpieces, e.g. profiles 1500 mm long instead of 3000 mm without rubbing or scraping of the warped profiles.

Preferably, the tooling 2 and the manifold frame 1 according to the present invention are made of acetal resins, preferably Delrin©, which allows to rapidly and cheaply obtain templates with a suitable shape of slots 5, starting from the CAD design of the profile to be easily machinable by well-known manufacturing methods. In a different embodiment, suitable materials can be used in order to print the components with a 3D printing machine.
1 manifold frame
2 tooling
3 vacuum outlet adapter
4 coating inlet adapters
5 profile slot
6 fixing means
7 fixing means hole
8 vacuum port
9°-ring
10 coating chamber
11 vacuum sensor adapter
24 simple coating tooling
25 selective coating tooling
26 cleaning tooling
41 entry template
42 centre template
43 diffusion ring
44 exit template
45 slot
46 fixing means
47 fixing means hole
49 coating path
51 entry template
52 centre template
53 diffusion ring
54 exit template
55 profile slot
56 fixing means
57 fixing means hole
58 shroud/mask
59 coating path
60 outfeed guide
61 blank entry template
62 centre template
63 diffusion ring
64 blank exit template
65 cleaning solution passage
66 tube
100 coating apparatus
101 infeed transport roller
102 infeed transport roller
103 infeed transport roller
104 infeed transport roller
105 infeed transport roller
110 polymerizing unit
114 coating agent pump

1. Apparatus (100) for coating a workpiece (66) with a coating agent, comprising a coating chamber (10); said apparatus (100) comprising:
a vacuum pump for generating a negative pressure in the coating chamber (10) compared to the pressure outside the chamber,
a fluid pump (114) and a reservoir for supplying and recycling said coating agent,
conveying means for the workpieces to be coated,
said coating chamber (10) being provided with slots (5) mimicking the shape of the workpiece (66) to be coated through which the workpiece (66) is conveyed, and with a path (49, 59) for said coating agent;
said coating chamber (10) comprises:
a manifold frame (1) fixedly placed with respect to the coating apparatus (100), comprising at least one vacuum outlet adapter (3), at least one coating inlet adapter (4), O-rings (9), preferably a vacuum sensor adapter (11),
a coating interchangeable tooling (2, 24, 25, 26),
wherein the tooling (2, 24, 25, 26) is mounted in/dismounted from the manifold frame (1) as an integral box-like unit,
characterized in that
said tooling (2, 24, 25, 26) comprises in this order:
an entry template (41, 51, 61),
a centre template (42, 52, 62),
a diffusion ring (43, 53, 63) with at least one vacuum port (8),
an exit template (44, 54, 64),
fixing means (6, 46, 56) and holes (47, 57) for the assembling of the box-like tooling (2, 24, 25, 26),
the tooling (2, 24, 25, 26) being assembled to the manifold frame (1) preferably with the interposition of O-rings (9) fixedly placed in the manifold frame (1).

2. Apparatus (100) for coating a workpiece (66) with a coating agent according to claim 1, wherein the entry template (41, 51, 61) has a diameter bigger than the exit template (44, 54, 64).

3. Apparatus (100) for coating a workpiece (66) with a coating agent according to claim 1, wherein the coating tooling (25) is specific for the specific workpiece to be coated and further comprises a shroud/mask (58) positioned inside said diffusion ring (53), for partial coating of said workpieces.

4. Apparatus (100) for coating a workpiece (66) with a coating agent according to claim 1, wherein the coating tooling (25) further comprises an outfeed guide (60) placed adjacent to the exit template (54) on its external side, for preventing the scraping of warped elongated coated workpieces.

5. Apparatus (100) for coating a workpiece (66) with a coating agent according to claim 1, wherein the tooling (24) is specific for the specific workpiece to be coated and the coating is an all-round coating.

6. Apparatus (100) for coating a workpiece (66) with a coating agent according to claim 1, further comprising a cleaning tool (26), wherein said cleaning tool is characterized by the absence of slots (5) in the entry template (61) and the exit template (64).

7. Apparatus (100) for coating a workpiece (66) with a coating agent according to claim 1 wherein the edges of the slots (45, 55) are machined flat, i.e. with a 90° angle.

8. Apparatus (100) for coating a workpiece (66) with a coating agent according to claim 1, wherein the edges of the slots (45, 55) are bevelled.

9. Apparatus (100) for coating a workpiece (66) with a coating agent according to claim 1, wherein the number and shape of fixing means (6) and holes (7) are such that no horizontal and vertical adjustment of the tooling (2) with respect to the manifold frame (1) is needed.

10. Apparatus (100) for coating a workpiece (66) with a coating agent according to claim 1, wherein the entry template (41, 51, 61), the centre template (42, 52, 62), the diffusion ring (43, 53, 63) and the exit template (44, 54, 64) of the tooling (2, 24, 25, 26) are made of Delrin© and produced through machining.

11. Apparatus (100) for coating a workpiece (66) with a coating agent according to claim 1, wherein the entry template (41, 51, 61), the centre template (42, 52, 62), the diffusion ring (43, 53, 63) and the exit template (44, 54, 64) of the tooling (2, 24, 25, 26) are obtained through 3D printing.

12. Method for coating a workpiece making use of an apparatus (100) according to claim 1, comprising the following steps:
A. machining three templates, namely an entry template (41), a centre template (42) and an exit template (44), so as to obtain in each of them a slot (45) mimicking the shape of the workpiece (66) to be coated and a suitable coating path (49);
B. assembling said three templates (41, 42 and 44) with the interposition of a diffusion ring (43) between the centre template (42) and the exit template (44); said components being held together through fixing means (46) and respective holes (47), in order to provide a first box-like coating tooling (24);
C. mounting said first coating tooling (24) as a single box-like unit in the manifold frame (1) which is provided with fixed O-rings (9), fixing it through fixing means (6) and holes (7) accessible from the infeed facing side, no adjustment between the manifold frame (1) and the tooling (24) being necessary;
D. coating a first batch of workpieces having a shape suitable for the slot (45) of the first coating tooling (24);
E. at the end of the workpiece batch, cleaning the coating chamber (10) if needed;
F. providing a second coating tooling (25) according to steps A-B for a new second batch of workpieces having a different shape from the shape of first slot (45);
G. optionally, inserting a shroud/mask (58) and/or an outfeed guide (60) into the second tooling (25);
H. mounting the second tooling (25) into the manifold frame (1) like in step C, so that the production cycle of a new batch can start.

13. Method for cleaning a coating apparatus (100) according to claim 12, wherein the cleaning step E comprises the following steps:
a. dismounting the used first coating tooling (24) from the manifold frame (1);
b. replacing the dismounted first coating tooling (24) with a cleaning tooling (26) and mounting it in the manifold frame (1) through the same fixing means (6) into holes (7);
c. emptying the coating agent reservoir and filling it with a suitable cleaning solution;
d. circulating said cleaning solution through the coating apparatus (100), following the same path of the coating agent;
e. after a suitable time or a suitable quantity of cleaning solution circulated in the coating apparatus (100), replacing the cleaning tool (26) by a second, clean coating tooling (25) suitable for the next batch of workpieces to be coated;
f. disassembling and cleaning off-line the first, dirty coating tool (24), and preparing it in order to be used for a future batch of workpieces.
